(19) United States
(12) Patent Application Publication
(10) Pub. No.: US 2025/0096246 A1
(43) Pub. Date: Mar. 20, 2025

(54) High-Energy-Density Rechargeable Manganese Battery

(71) Applicants: Robert Bado, Delray Beach, FL (US); Artem Madatov, North Bethesda, MD (US)

(72) Inventors: Robert Bado, Delray Beach, FL (US); Artem Madatov, North Bethesda, MD (US)

(21) Appl. No.: 18/948,375

(22) Filed: Nov. 14, 2024

(51) Int. Cl. H01M 4/38; H01M 4/02; H01M 4/58; H01M 4/62; H01M 10/36

(52) U.S. Cl. CPC H01M 4/38; H01M 4/58; H01M 4/625; H01M 10/36; H01M 2004/027; H01M 2300/0002

(57) ABSTRACT

The invention provides a high-energy-density rechargeable battery, comprising negative and positive electrodes made of metallic manganese and its compounds, liquid anhydrous hydrogen fluoride with additives of fluorides and bifluorides of alkali metals and complex fluorides of manganese (II) as an electrolyte, and a positive electrode comprising a mixture of higher manganese fluorides and fluorides of alkaline earth metals, and their reaction products, insoluble complex compounds: calcium manganese (III) fluoride Ca²⁺[MnF₅]²⁻ and calcium manganese (IV) fluoride Ca²⁺[MnF₆]².

### FIELD OF THE INVENTION

The invention relates to the field of energy, namely to devices for storing electrical energy, secondary batteries, also known as rechargeable batteries.

### BACKGROUND OF THE INVENTION

The use of rechargeable batteries, especially in transport, is becoming increasingly widespread. In recent years, electric batteries have even been used as primary energy source in manned and unmanned electric ground vehicles, unmanned and even manned electric aircraft, as well as many other applications. This requires a high energy density and high volumetric energy density of the batteries. Consequently, the choice of active electrochemical materials for creating new battery chemistries is narrowed to materials with an equivalent mass from 7 g/mol-eq. (Lithium) to 100 g/mol-eq.

It is clear that, given the atomic mass of chemical elements, the choice is limited to the first four periods of the periodic table of elements. At the same time, it is also necessary to take into account the market value of chemical materials, which depends on the abundance of the element in the earth's crust.

The present inventors propose to use manganese Mn with an equivalent mass of 23 g/mol-eq. for both the negative and positive electrodes.

Manganese has a fairly high standard electrode potential of −1.186 V.

Fluorine F, with an equivalent mass of 9 g/mol-eq., is selected by the present inventors as an auxiliary material with best electron-acceptor properties.

Manganese and fluorine are widespread elements, they are widely available and have a low market price. The present inventors also propose to use liquid anhydrous hydrogen fluoride as an electrolyte with a high electrolytic strength and virtually zero concentration of hydrogen ions.

The most common chemical sources of electric current are those with a positive electrode containing manganese dioxide (IV) as an electron acceptor (depolarizer), an aqueous alkali solution as a liquid electrolyte, and a negative electrode containing metallic zinc (Leclanche cell).

Using metallic manganese instead of zinc would increase the specific energy of the cell and reduce the cost. However, the oxidation products of manganese are insoluble in the alkaline electrolyte, rendering the cell unusable.

In an acidic aqueous electrolyte, severe corrosion of the manganese negative electrode (self-discharge) with the release of hydrogen is observed.

However, the USSR Author's Certificate No. 113475 class 21b “Galvanic cell with electrodes made of manganese dioxide and metallic manganese” describes a battery with a negative electrode made of metallic manganese immersed in an aqueous electrolyte containing ammonium chloride. According to the description, the galvanic pair metallic manganese-manganese dioxide (IV) has a higher electromotive force than the galvanic pair zinc-manganese dioxide (IV).

The Chinese Patent CN102511092A “Alkaline primary cells with cathodes comprising manganese” describes a battery with a metallic manganese electrode and an aqueous electrolyte additionally containing potassium hydroxide, sodium hydroxide, lithium hydroxide, zinc chloride, ammonium chloride, magnesium perchlorate and magnesium bromide. The active cathode material is selected from the group consisting of the following materials: manganese dioxide, electrolytic manganese dioxide (EMD), chemical manganese dioxide (CMB) and high-power electrolytic manganese dioxide (HPE). Said battery comprises anode, negative electrode, is arranged on spacer body and electrolyte between anode and the negative electrode. Said negative electrode also comprises manganese.

The disadvantages of the above-described battery include the alkaline reaction of the declared water-based electrolyte. This leads to passivation (deactivation) of the negative electrode during battery discharge due to sedimentation of Mn²⁺ ions in the form of insoluble manganese hydroxide (II) on the electrode surface. The insoluble sediment prevents circulation of the electrolyte and complicates the normal operation of the battery. The above-mentioned battery is not rechargeable.

The present inventors set a goal of creating a rechargeable battery with a metallic manganese negative electrode (anode) immersed in an acidic electrolyte. At the same time, the electrolyte should not cause corrosion of the anode.

Similar battery is described in patent US20110262816A1 “Polyhydrogen fluoride-based battery”. According to the description, the basis of the battery electrolyte is fluorinated aprotic ionic liquids containing dissolved organic salts, such as fluorides, bifluorides and polybifluorides of quaternary salts of alkyl-substituted ammonium, as well as inorganic salts, fluorides and bifluorides of metals: alkali and alkaline earth, ammonium, as well as transition metals, such as manganese and cobalt. The said salts are a source of fluoride ions, which participate in the dissolution of the active material of the anode.

One of the disadvantages of the above-described battery includes an electrolyte based on organic ionic liquids. Such electrolyte has high viscosity, insufficient ionic strength and conductivity, as well as low frost resistance, all ionic liquids harden at a temperature not lower than minus 25° C. At the same time, aircraft, spacecraft, other special purpose, and preferably ground electric vehicle, batteries must remain operational at least up to minus −60° C. In addition, it is indicated that the positive electrode of the above-described battery contains fluorides of transition metals, in particular manganese, in a low oxidation state, namely MnF₂. This leads to a low value of the positive potential of the electrode, and, consequently, to a low specific energy of the battery.

The present inventors believe that in order to increase the potential, the positive electrode should contain manganese compounds in higher oxidation states, manganese fluorides (III) and (IV), MnF₃ and MnF₄.

Higher manganese fluorides are stable in the form of their complex derivatives: calcium manganese (III) fluoride Ca²⁺[MnF₅]²⁻ and calcium manganese (IV) fluoride Ca²⁺[MnF₆]²⁻.

Also, the use of liquid anhydrous hydrogen fluoride instead of fire-hazardous organic ionic liquids as the basis of the liquid electrolyte will improve the specific characteristics and frost resistance of the battery.

In addition to the fact that anhydrous hydrogen fluoride at moderate temperatures does not cause corrosion (self-discharge) of the metallic manganese anode, it promotes the removal of poorly soluble MnF₂ from the anode into the electrolyte in the form of highly soluble complex fluorides of manganese (II) and alkali metals with the general formula Me⁺[MnF₃]⁻ and Me²⁺[MnF₄]⁻², where Me⁺ is Li⁺, Na⁺, K⁺, Rb⁺, Cs⁺ or NH₄⁺.

### SUMMARY OF THE PRESENT INVENTION

The invention provides a high-energy-density rechargeable battery, comprising negative and positive electrodes made of metallic manganese and its compounds, liquid anhydrous hydrogen fluoride with additives of fluorides and bifluorides of alkali metals and complex fluorides of manganese (II) as an electrolyte, and a positive electrode comprising a mixture of higher manganese fluorides and fluorides of alkaline earth metals, and their reaction products, insoluble complex compounds: calcium manganese (III) fluoride Ca²⁺[MnF₅]²⁻ and calcium manganese (IV) fluoride Ca²⁺[MnF₆]²⁻.

The battery is characterized by the following properties:
Anode made of metallic manganese and cathode made of manganese fluorides, thus increasing specific exchange current on the electrodes, and energy density of the battery;
Capacity of the manganese anode is 18% greater than that of the zinc anode;
Capacity of the fluoromanganese cathode is 87% greater than that of the manganese oxide anode;
Potential of the manganese anode is 70% greater than that of the zinc anode;
Specific energy content of the battery is 375% higher compared to the zinc-manganese-oxide battery;
Specific electrical resistance of the hydrogen-fluoride electrolyte is 3 times lower than the resistance of an organic electrolyte;
The battery's resistance to low temperatures reaches −80° C.;
The battery is rechargeable with a high number of charge cycles;

### BRIEF DESCRIPTION OF THE DRAWINGS

FIG. 1 is a schematic design of the battery

### DETAILED DESCRIPTION OF THE INVENTION

The goal of creating a compact and capacious rechargeable battery with negative and positive electrodes made of metallic manganese and its compounds was achieved by the present inventors by using liquid anhydrous hydrogen fluoride with additives of fluorides and bifluorides of alkali metals and complex fluorides of manganese (II) as an electrolyte, and by making a positive electrode from a mixture of higher manganese fluorides and fluorides of alkaline earth metals, and their reaction products, insoluble complex compounds: calcium manganese (III) fluoride Ca²⁺[MnF₅]²⁻ and calcium manganese (IV) fluoride Ca²⁺[MnF₆]²⁻.

The following electrochemical system is proposed:

Mn|MnF₂,HF,KF,K⁺[MnF₃]⁻|MnF₃,CaF₂,Ca²⁺[MnF₅]²⁻

### Electrochemical Discharging Reactions:

$$Anode ( - ) Mn - 2 e \text{=>} {Mn}^{2 +}$$

$$Cathode ( + ) {Mn}^{3 +} + e \text{=>} {Mn}^{2 +}$$

### Electrochemical Charging Reactions:

$$Anode ( - ) {Mn}^{2 +} + 2 e \text{=>} {Mn}^{2 +}$$

$$Cathode ( + ) {Mn}^{2 +} - e \text{=>} {Mn}^{3 +}$$

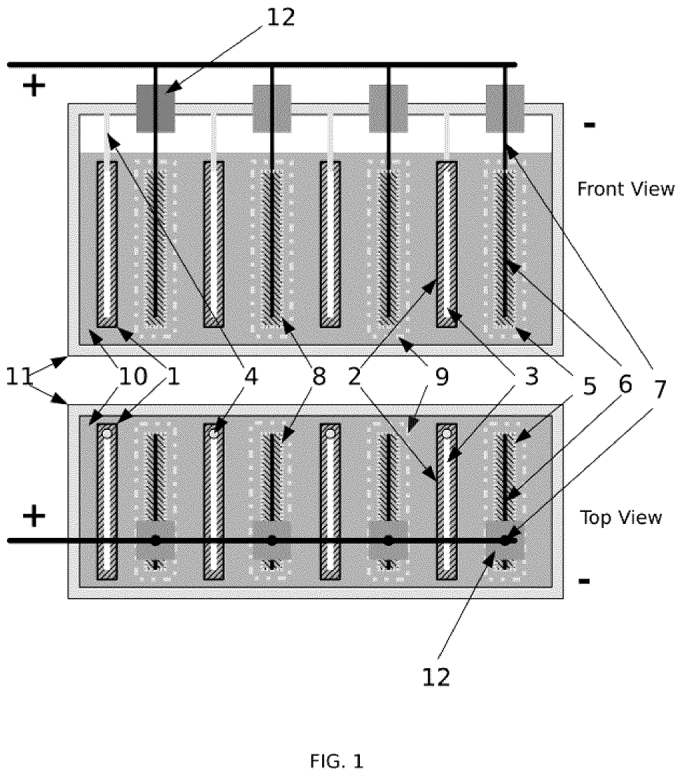

The proposed rechargeable battery is based on the difference in redox potentials of manganese: Mn⁰ (−1.186 V)−Mn²⁺(−0.05 V)−Mn³⁺(+1.51 V). Each battery cell consists of an anode, cathode, electrolyte and separator, enclosed in a sealed case (FIG. 1).

The negative electrode (anode) 1 consists of a metallic manganese layer 2 plated over a base 3. The anode base 3 is a flat thin metal plate with a rough or ribbed textured surface with an electrical conductor 4 attached to it. The anode base and electrical conductor material must be stable in anhydrous hydrogen fluoride, and its standard electrode potential in acidic environment must be more positive than that of manganese. Therefore, the best material for the anode base and electrical conductor is nickel.

Metallic manganese is stable in anhydrous hydrogen fluoride at low temperatures, thus the anode self-discharge will be minimal.

The positive electrode (cathode) 5 consists of a cathode base 6 with an attached electrical conductor 7, a cathode body 8 and a shell-separator 9.

The cathode base is a mesh or a perforated plate made of a material resistant to the influence of manganese trifluoride in anhydrous hydrogen fluoride. The best material for the cathode base is graphite or carbon fabric, and for the electrical conductor, nickel.

The cathode body material is pressed onto the cathode base. The cathode body material consists of conductive components (carbon fabric, acetylene black, flaked graphite, activated charcoal, thermoanthracite) mixed with calcium fluoride CaF₂ and manganese trifluoride MnF₃ or their complex insoluble compound, calcium manganese (III)-fluoride Ca²⁺[MnF₅]²⁻.

After the cathode body material is pressed onto the cathode base, the entire cathode is enclosed in a mesh cover to prevent the cathode body material from shedding. The mesh cover is made of a non-conductive material that is resistant to the influence of manganese trifluoride in anhydrous hydrogen fluoride. The best material for a cathode cover is polytetrafluoroethylene (Teflon).

Anhydrous electrolyte 10 is prepared using liquid hydrogen fluoride HF, in which potassium bifluoride and a complex compound of manganese fluoride (II), K⁺[MnF₃]⁻ are dissolved. Instead of potassium bifluoride, bifluoride of any other alkali metal or ammonium can be used. Due to formation of a liquid azeotropic mixture of HF and KF (adduct HF·KF), the boiling point of the liquid electrolyte increases to approximately +80° C. at normal atmospheric pressure at sea level. Nevertheless, it is recommended to enclose the battery cells in a case that prevents leakage of electrolyte vapors and inward moisture penetration.

The battery case 11 is hermetically sealed, made of nickel-plated stainless steel, and capable of withstanding internal pressure of up to at least 20 atm, so the battery would withstand overheating up to +120° C. at a saturated HF vapor pressure of about 10 atm without depressurization.

The battery is cooled by convection of the liquid electrolyte and heat loss to the outside environment through the metal case. The battery is frost-resistant up to −80° C. (the freezing point of anhydrous HF is −83° C.)

The battery cell potential difference for the open circuit is 2.7 V, under the load 2.5 V. The specific energy content of a real battery (50% active materials, 30% electrolyte, 20% case and electrical conductors) is 3140 Wh/kg.

The technology for mass production of batteries includes application of a submillimeter layer of metallic manganese to the anode base made of nickel foil. Manganese is applied to the base in a 0.1-1.0 mm layer.

In one of the embodiments, the cathode is a package of flat rigid plates (graphite or glass graphite base) or a long tape rolled into a roll (carbon fabric base). A millimeter-thick layer of paste made of a mixture of calcium fluoride, anhydrous crystalline MnF₃, or pre-prepared calcium manganese (III)-fluoride Ca²⁺[MnF₅]²⁻, with conductive additives is pressed onto the cathode base. The finished cathode is placed inside the shell-separator 9 made of thin corrugated mesh. The mesh is made of a chemically resistant electrical insulator, preferably polytetrafluoroethylene (Teflon).

Placed between the anode and cathode plates, the shell-separator protects the battery cell from short-circuiting and also provides adequate space for the required volume of electrolyte. Then, the cathode plates are laid parallel to the anode plates, forming an electrode assembly.

The electrode assemblies (anode with cathode and separator) are rolled into a cylinder (or flat tetrahedron or triangular prism) or stacked, depending on the required final shape of the cell, and placed in the metal battery case 11. The electrical conductors of the cathode (+) are placed in ceramic insulators 12 made of calcium fluoride or any other suitable material. The electrical conductors of the anode (−) can be connected to the battery case, which in this case becomes a negative terminal of the battery. The battery case is filled with liquid electrolyte and hermetically sealed.

When the anode and cathode are immersed in liquid hydrogen fluoride, equilibrium potentials arise and are established on the surface of the electrodes.

At the anode, neutral atoms of metallic manganese are ionized, giving up electrons and turning into manganese ions (II) Mn²⁺:

$$Mn \text{=>} {Mn}^{2 +} + 2 e$$

Electrons accumulate on the metallic anode and shift its potential to electronegativity until the potential reaches the equilibrium (for Mn⁰ the equilibrium potential is −1.186 V). At this potential, metallic manganese ceases to dissolve. Manganese ions (II) are solvated by polar HF molecules and leave the metal lattice of the anode, remaining on the surface of the anode in the form of a film of atomic thickness. There they react with potassium bifluoride KHF₂ and fluorine ions F⁻, forming a highly soluble complex compound K⁺[MnF₃]⁻:

$${Mn}^{2 +} + 2 {F}^{-} + {KHF}_{2} \text{<=>} {K}^{+} + {[ {MnF}_{3} ]}^{-} + HF$$

Potassium ions leave the anode surface into the electrolyte under the influence of diffusion, and the anions of the complex manganese trifluoride move towards the cathode under the influence of an electric field.

In the cathode body at the contact boundary of calcium manganese (III)-fluoride crystals Ca²⁺[MnF₅]²⁻ and conductive additives (carbon), a reaction of reduction of Mn³⁺ ions to Mn²⁺ ions occurs due to the conduction electrons of carbon:

$${{Ca}^{2 +} [ {MnF}_{5} ]}^{2 -} + e \text{=>} {{Ca}^{2 +} [ {MnF}_{4} ]}^{2 -} + {F}^{-}$$

or in general terms:

$${Mn}^{3 +} + e \text{=>} {Mn}^{2 +}$$

When conduction electrons are captured by manganese ions (III) located in the ionic lattice of Ca²⁺[MnF₅]²⁻ and electrons are spent on reduction to manganese ions (II), the cathode acquires a potential shifted to the positivity. As the conduction electrons of carbon are consumed, the potential becomes increasingly positive until it reaches the equilibrium (for Mn³⁺ the equilibrium potential is +1.51 V). At this potential value, Mn³⁺ ceases to be reduced. Manganese ions (II) remain in the crystal lattice of insoluble Ca²⁺[MnF₄]²⁻, and fluoride ions F⁻ are solvated by polar HF molecules, leave the crystal lattice of the cathode and move in the electrolyte towards the anode under the influence of an electric field.

The electric field in the electrolyte is caused by the potential difference between the anode and cathode. The potential difference between the anode and cathode in equilibrium is 2.696 V (in an acidic environment at 0° C.).

When the anode is connected to the cathode through an external electric circuit, the potential difference causes electrons to flow from the anode to the cathode, thus, an electric current is generated. Therefore, the equilibrium of potentials is disturbed: the anode potential becomes more positive, and the cathode potential becomes more negative (the so-called “current polarization”). As a result, the dissolution of metallic manganese begins again at the anode and the anode potential again shifts to electronegativity. At the cathode, the reduction of Mn³⁺ ions in the Ca²⁺[MnF₅]²⁻ crystal lattice to Mn²⁺ ions begins again, and the cathode potential again shifts to electropositivity. At a steady current value, a dynamic equilibrium of potentials is established. At a specific current density on the anode and the cathode that does not exceed the exchange currents of the specified electrochemical reactions, the potential difference between the anode and the cathode is approximately 2.5 V (at +20° C.).

The current in the external circuit continues until the active materials of the electrodes are completely exhausted, i.e. metallic manganese on the anode and Ca²⁺[MnF₅]²⁻ on the cathode. After the active materials have completely converted (the battery is completely discharged), the battery must be charged.

The battery is charged by passing direct electric current through it so that the electrons pass through the electrodes in the opposite direction, i.e. from the cathode to the anode. To do this, a (+) wire from an external power source is connected to the battery cathode, and a (−) wire to the anode. The battery charging process is essentially electrolysis and positively charged ions (+), cations, move to the negative electrode, now the cathode. Negatively charged ions (−), anions, move to the positive electrode of the battery, now the anode.

When a positive potential is applied to the anode, the conduction electrons of carbon in the anode leave the anode and go into the external circuit. The anode acquires an increasingly positive potential. When the anode reaches a potential more positive than +1.51 V in the anode body, the oxidation of complex anions of manganese (II) fluoride begins on the surface of carbon particles to form manganese (III) fluoride:

$${[ {MnF}_{3} ]}^{-} - e \text{=>} {MnF}_{3}$$

or, in general terms:

$${Mn}^{2 +} - e \text{=>} {Mn}^{3 +}$$

Soluble manganese trifluoride MnF₃ diffusely penetrates into the crystals of calcium manganese (II) fluoride Ca²⁺[MnF₄]²⁻ and oxidizes it to calcium manganese (III) fluoride Ca²⁺[MnF₅]²⁻:

$${{Ca}^{2 +} [ {MnF}_{4} ]}^{2 -} + {MnF}_{3} \text{=>} {MnF}_{2} + {{Ca}^{2 +} [ {MnF}_{5} ]}^{2 -}$$

If the anode potential becomes more positive than +2.26 V, then the manganese ions are oxidized to manganese (IV):

$${[ {MnF}_{3} ]}^{-} - 2 e + {F}^{-} \text{=>} {MnF}_{4}$$

Then the oxidation-reduction reaction of formation of calcium manganese (IV) fluoride Ca²⁺[MnF₆]²⁻ can proceed:

$${{Ca}^{2 +} [ {MnF}_{4} ]}^{2 -} + {MnF}_{4} \text{=>} {MnF}_{2} + {{Ca}^{2 +} [ {MnF}_{6} ]}^{2 -}$$

Insoluble Ca²⁺[MnF₅]²⁻ and Ca²⁺[MnF₆]²⁻ form small crystals on the surface of graphitized carbon particles in the anode body. Part of the reduced manganese fluoride (II) forms complex ions again:

$${MnF}_{2} + {KHF}_{2} \text{<=>} {K}^{+} + {[ {MnF}_{3} ]}^{-} + HF$$

Complex anions of manganese (II) [MnF₃]⁻ in the liquid electrolyte move again under the influence of an electric field towards the anode (+) and are discharged on the surface of the conductive particles of the anode (carbon). The process continues until all calcium manganese (II) fluoride in the anode body is converted into calcium manganese (IV) fluoride⁻.

The manganese fluoride (II) formed at the anode is soluble in the electrolyte and partially dissociates:

$${MnF}_{2} \text{<=>} {Mn}^{2 +} + 2 {F}^{-}$$

Mn²⁺ cations move under the influence of an electric field towards the cathode. Electrons, driven by an electric field of an external source of electric current, leaving the anode, arrive to the cathode and shift its potential to electronegativity.

When the cathode potential becomes more negative than −1.186 V, a reaction of reducing manganese cations (II) to metallic manganese begins on the cathode:

$${Mn}^{2 +} + 2 e \text{=>} Mn$$

Metallic manganese is deposited on the base of the cathode in a more or less even layer, and new Mn²⁺ cations move under the influence of an electric field towards the surface of the cathode. The loss of manganese (II) Mn²⁺ cations in the electrolyte is replenished by the decomposition of the potassium-manganese (II) trifluoride complex:

$${K}^{+} + {[ {MnF}_{3} ]}^{-} + HF \text{<=>} {Mn}^{2 +} + 2 {F}^{-} + {KHF}_{2}$$

The process continues until the supply of Mn²⁺ ions in the electrolyte is exhausted. After the battery charging process is complete, approximately ⅓ of the manganese is on the cathode in the metallic state, ⅔ of the manganese is on the anode in the form of calcium manganese (III) fluoride Ca²⁺[MnF₅]²⁻ and calcium manganese (IV) fluoride Ca²⁺[MnF₆]²⁻. In a fully charged battery, the content of Mn²⁺ in the electrolyte is insignificant.

1. An electrochemical device consisting of a negative electrode containing metallic manganese, a positive electrode containing manganese compounds mixed with conductive carbon additives, a separator and a liquid electrolyte containing soluble manganese compounds, fluorine ions, bifluoride ions, alkali metal or ammonium ions, characterized in that anhydrous hydrogen fluoride is used as the liquid electrolyte.

2. The electrochemical device according to claim 1, characterized in that in the anhydrous hydrogen fluoride are dissolved complex fluorides of manganese (II) and at least one of the alkali metals: complex compounds of the general formula Me⁺[MnF₃]⁻ and Me²⁺[MnF₄]⁻², where Me⁺ is Li⁺, Na⁺, K⁺, Rb⁺, Cs⁺ or NH₄⁺.

3. The device according to claim 1, characterized in that the positive electrode contains manganese fluorides (III) and (IV), MnF₃ and MnF₄.

4. The device according to claim 1, characterized in that the positive electrode contains complex fluorides of manganese (III), (IV) and at least one of the alkaline earth metals, insoluble in anhydrous hydrogen fluoride: complex compounds of the general formula Me²⁺[MnF₅]²⁻ and Me²⁺[MnF₆]²⁻, where Me²⁺ is Be²⁺, Mg²⁺, Ca²⁺, Sr²⁺, Ba²⁺.
